(19) United States
(12) Patent Application Publication
(10) Pub. No.: US 2017/0011390 A1
(43) Pub. Date: Jan. 12, 2017

(54) SYSTEM FOR FACILITATING DIGITAL WALLET TRANSFERS

(71) Applicant: BANK OF AMERICA CORPORATION, Charlotte, NC (US)

(72) Inventors: Matthew Hsieh, Charlotte, NC (US); Jade Michelle Le Vo-Dinh, Charlotte, NC (US); Carrie Anne Hanson, Charlotte, NC (US); Peter John Bertanzetti, Charlotte, NC (US); Alicia C. Jones-McFadden, Fort Mill, SC (US); David M. Grigg, Rock Hill, SC (US)

(21) Appl. No.: 14/796,865

(22) Filed: Jul. 10, 2015

(51) Int. Cl. G06Q 20/36; G06Q 20/10

(52) U.S. Cl. CPC G06Q 20/36; G06Q 20/108

(57) ABSTRACT

Embodiments of the invention relate to systems and methods for facilitating digital wallet transfers. In particular, the embodiments of the invention relate to system configured to create an electronic wallet capable of receiving funds from an online transaction. The system may further cause a mobile device to install a banking application for managing the electronic wallet, wherein the banking application enables a user to create a financial account and transfer funds available to the electronic wallet to the financial account. Based on the user interacting with the banking application, the system creates a financial account capable of receiving funds from the electronic wallet. The system identifies that the electronic wallet has received funds, and based on such identification, the system transfers an amount of funds available to the electronic wallet to the financial account.

### FIELD OF THE INVENTION

The invention is directed to systems, methods and computer program products for enabling and incentivizing a user to transfer funds from an electronic wallet to a financial account based on funds being made available to the electronic account.

### BACKGROUND

Mobile wallets and electronic wallets are increasing in popularity to handle transactions online transaction. Similar to a financial account, electronic wallets may have funds be made available. However, unlike a typical bank account, electronic wallets do not offer the same protection as a typical bank account. Therefore, there exists a need to incentivize users to transfer funds made available to an electronic wallet to a financial account.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention are directed to systems, methods, and computer program products that enable a user to transfer funds from an electronic wallet to a financial account established to receive funds from the electronic wallet. In some embodiments, the invention creates an electronic wallet capable of receiving funds from an online transaction, where the electronic wallet. Additionally, the system causes a mobile device to install a banking application for managing the electronic wallet, wherein the banking application enables a user to create a financial account and transfer funds available to the electronic wallet to the financial account. The banking application additionally enables a user to create a financial account for receiving funds from the electronic wallet.

Based on the user interacting with the banking application, the system creates a financial account capable of receiving funds from the electronic wallet. With the financial account, the system may identify that the electronic wallet has received funds. Once the system determines that funds are available for the electronic wallet, the system may prompt the user to transfer the funds available to the electronic wallet to the financial account. In some embodiments, the system may further present an offer to the user to incentivize the user to transfer the funds. Based on the user interacting with the banking application to transfer funds, the system may transfer an amount from the electronic wallet to the financial account.

In other embodiments, the system may be configured to identify an online merchant account used by the user to perform a transaction, wherein the user is a merchant of the transaction, wherein the electronic wallet receives funds as a result of the user completing a transaction, and wherein identifying that the electronic wallet has received funds is based on determining the user completed the transaction.

While in other embodiments, the transaction is held for a waiting period, and wherein the executable code further causes the one or more processor to extend credit to the electronic wallet during the waiting period, and receive proceeds of the transaction.

In yet other embodiments, the executable code further causes the one or more processors to receive a maximum balance for the electronic wallet, determine that an amount of funds available to the electronic wallet exceeds the maximum balance of the electronic wallet, wherein the amount transferred from the electronic wallet to the financial account is based on ensuring the funds available to the electronic wallet are not less than the maximum balance.

Further, in other embodiments, the mobile wallet application enables the user to make a request that at least a portion of the funds available to the electronic wallet are transferred to the financial account; wherein the executable code further causes the one or more processors to receive the request; and wherein transferring the amount from the electronic wallet to the financial account is further based upon receiving the request.

In some embodiments, the financial account is an interest bearing account.

While in other embodiments, the system is configured to determine an incentive for causing the user to transfer a portion of the funds available to the electronic wallet from the electronic wallet to the financial account; cause the banking application to present the incentive to the user, receive a request to transfer the portion of the funds available to the electronic wallet, and wherein complete the incentive based on receiving the request to transfer the portion of the funds available to the electronic.

### BRIEF DESCRIPTION OF THE DRAWINGS

Having thus described embodiments of the invention in general terms, reference will now be made to the accompanying drawings, where:

FIG. 1 is a diagram illustrating a network environment system, in accordance with embodiments of the present invention;

FIG. 2 is a block diagram illustrating an electronic wallet management system in accordance with various embodiments, of the present invention.

FIG. 3 is a block diagram illustrating a mobile device capable of installing a banking application in accordance with various embodiments of the present invention;

FIG. 4 is a high level process flow illustrating a method for enabling a user to transfer funds from an electronic wallet to a financial account in accordance with various embodiments of the present invention;

FIG. 5A is a process flow illustrating a method for incentivizing a seller to transfer funds available to an electronic wallet as a result of completing an online sale to a financial account in accordance with various embodiments of the present invention; and

FIG. 5B is a process flow illustrating a method for incentivizing a seller to transfer funds available to an electronic wallet as a result of completing an online sale to a financial account in accordance with various embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the present invention are directed to systems, methods and computer program products that enable a user to transfer funds from an electronic wallet to a financial account established to receive funds from the electronic wallet. The system provides incentives and/or offers to a user to transfer funds available to the electronic wallet to a financial account managed by a financial institution.

In some embodiments, an “entity” may refer to a business entity that is either maintaining or acting on behalf of an entity maintaining one or more databases for monitoring and housing data. For example, in exemplary embodiments, an entity may be a financial institution, or one or more parties within the financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g., a banking account), a savings account, an investment account, a money market account, a time deposit, a demand deposit, a pre-paid account, a credit account, a non-monetary customer profile that includes only personal information associated with the customer, or the like. The account is associated with and/or maintained by the entity. In other embodiments, an entity may not be a financial institution. In still other embodiments, the entity may be the merchant itself.

The term “offer” may include merchant sales, coupons, discounts, rewards points/loyalty discounts, and/or the like. In this way, offers may include information detailing the terms of the one or more offers, such the location of the offer (e.g. online, in-store, or the like), merchant name, merchant telephone number, merchant address, merchant hours/days of operation, merchant web address, offer expiration date, product description, product name, product price, product image, hyperlink to the product image on the merchant website or a third party website, offer image, hyperlink to the offer image on the merchant website or a third party website, and the like. The term “advertisement” as used herein may include any notice or announcement in a public medium promoting a product, service, or event or publicizing an opportunity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to customers.

In some embodiments, the “user” or “seller” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). The terms user, customer and/or consumer may be used interchangeably throughout the specification.

In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself. As used herein, a “bank account” refers to a credit account, a debit/deposit account, or the like.

Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, an “electronic wallet” or “mobile wallet” may refer to a system that facilitates the completion of an electronic financial transaction. The system may comprise at least an application executed by an electronic device and an electronic wallet management system. The electronic wallet may be used to both send and receive funds associated with a transaction. Where the electronic wallet is used to send funds, the electronic device may include a communication device for communicating with a merchant transaction machine (e.g. Point-of-Sale Terminal). The communication device may be based on near field communication (NFC), Bluetooth, and the like. The fund transfer process is initiated when the mobile device communicates with a merchant transaction machine. A link is created by the electronic device and the merchant transaction machine. After the link is complete, the merchant transaction machine may communicate transaction details to the electronic device. Upon receiving the transaction details, the electronic device may enable the user to submit security credentials. The electronic device may receive the security credentials and authenticate such credentials. The electronic device may then communicate the transaction details to the electronic wallet management system which processes the transaction using standard banking transactions (e.g. ACH transfer).

In some embodiments, the electronic wallet may send funds using the electronic wallet with using an electronic device as described above. The user may initiate a transaction over a network site by linking the electronic wallet with the network site. For example, a merchant may offer for sale a product which the user desires to purchase. The merchant is an online retailer. The user interacts with the merchant network site to perform a transaction to buy the product. The user may supply the electronic site with an identification of the electronic wallet. The merchant may then communicate payment instructions to the electronic wallet.

Based on receiving these instructions, the electronic wallet management system may complete the transaction.

In other embodiments, the electronic wallet may be used to receive funds. The electronic wallet may be associated with an identifier (e.g. email, phone number, etc.) that the user may give to a payor. The electronic wallet may receive a request to transfer money to the user from an account of the payor. The request may include the identifier and using the identifier, the electronic wallet management system may direct received funds to the electronic wallet of the user.

The electronic wallet management system stores financial information for the wallet. This information may include funds available to the electronic wallet, financial accounts connected to the electronic wallet and the like. The electronic wallet management system may communicate with the electronic device to display the financial information to the user and receive instructions from the user for managing the electronic wallet.

In some embodiments, the electronic wallet is connected to various financial accounts of a user for transferring money between the financial account and the electronic wallet. For example, a user may connect a checking account managed by the user with the electronic wallet. After the financial account and the electronic wallet are connected, the user may direct the electronic wallet management system to transfer money between the financial account and the electronic wallet.

In some embodiments, the electronic wallet is dissimilar to a traditional bank account, where the bank account has actual control over the funds within the account. An electronic wallet may instead receive funds on behalf of a user and store such funds in a collective account. The electronic wallet management system may then make funds available to the electronic wallet. When the user requests a transaction be performed using the electronic wallet, the funds are paid using the collective account.

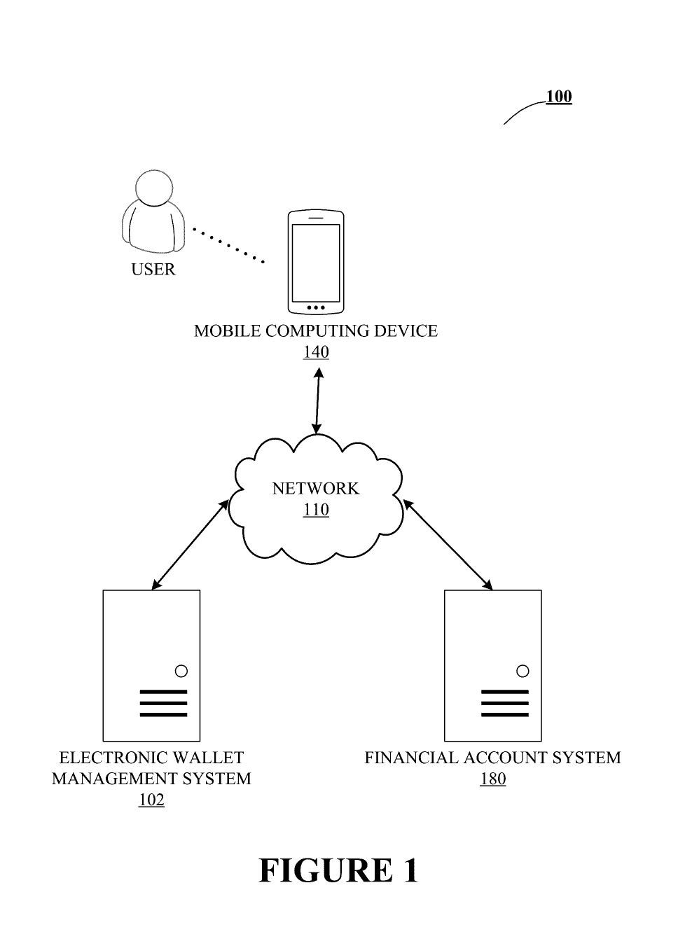

Referring to FIG. 1, a network environment 100 is illustrated in accordance with embodiments of the present invention. As illustrated in FIG. 1, the electronic wallet management system 102 is operatively coupled via a network 110 to the mobile computing device 140 and/or a financial account system 180. In this configuration, the electronic wallet management system 102 may send information to and receive information from the mobile computing device and/or the financial account system 180. Additionally, the mobile computing device 140 may send and receive information directly from the financial account system 180. FIG. 1 illustrates only one example of an embodiment of a network environment 100, and it will be appreciated that in other embodiments one or more of the systems, devices, or servers may be combined into a single system, device, or server, or be made up of multiple systems, devices, or server.

The network 110 may be a global area network (GAN), such as the Internet, a wide area network (WAN), a local area network (LAN), a telecommunication network or any other type of network or combination of networks. The network 110 may provide for wire line, wireless, or a combination wire line and wireless communication between devices on the network 110.

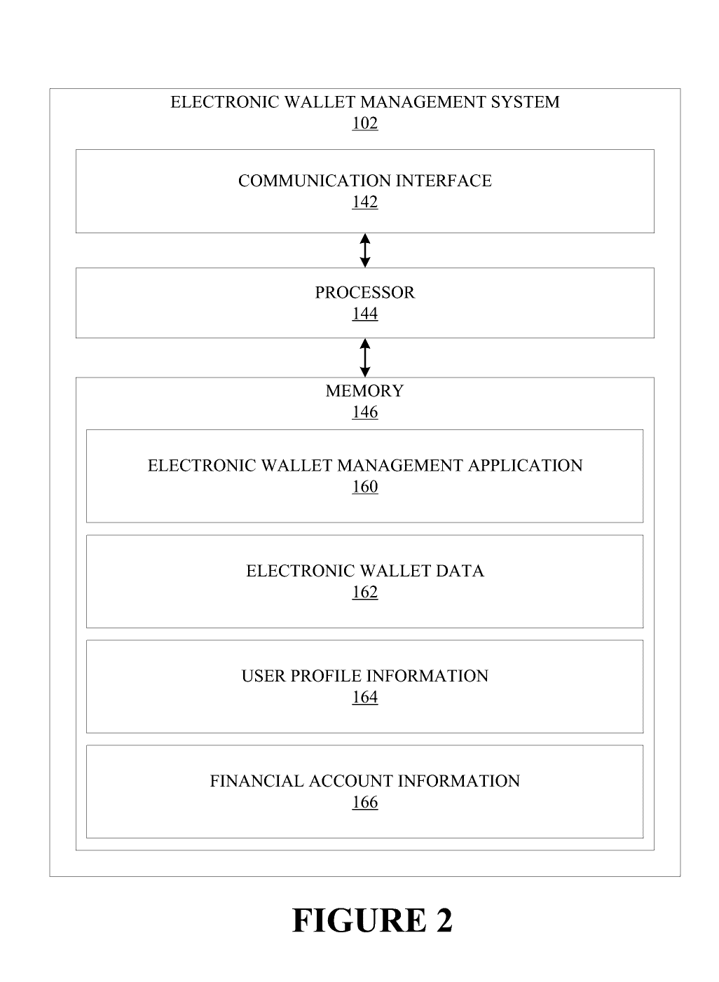

Referring now to FIG. 2, the electronic wallet management system 102 generally comprises a communication device 142, at least one processor 144, and a memory device 146. As used herein, the term “processor” or “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the electronic wallet management system 102 are allocated between these processing devices according to their respective capabilities. The processing device may include functionality to operate one or more software programs based on computer readable instructions thereof, which may be stored in a memory device.

The processor 144 is operatively coupled to the communication interface 142 to communicate with the network 101 and other devices on the network 101. As such, the communication interface 142 generally comprises a modem, server, or other device for communicating with other devices on the network 101.

As further illustrated in FIG. 2, the electronic wallet management system 102 comprises an electronic wallet management application 160. The electronic wallet management application 160 may perform one or more of the steps and/or sub-steps discussed herein and/or one or more steps not discussed herein. For example, in some embodiments, the electronic wallet management application 160 may perform functions to manage an electronic wallet.

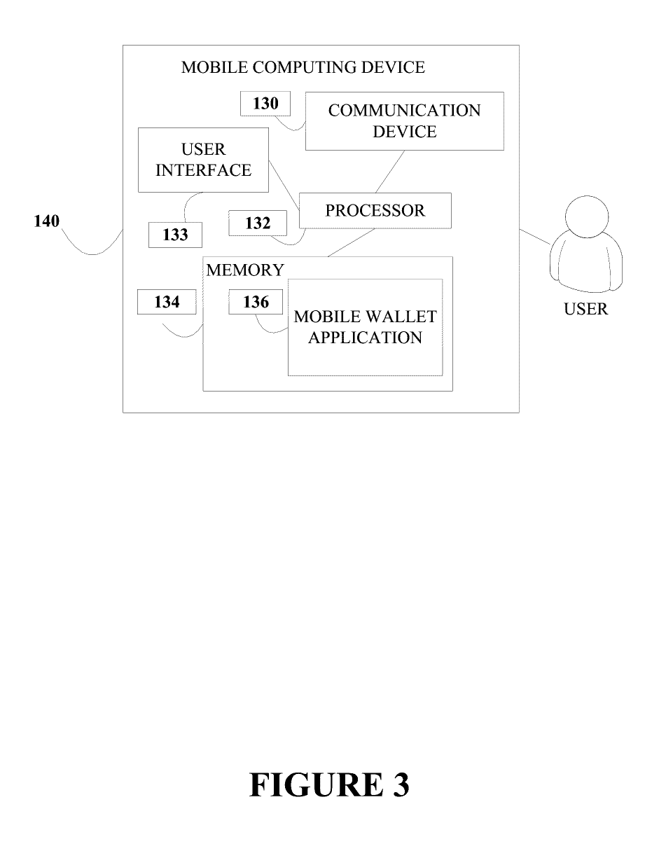

Referring now to FIG. 3, the mobile computing device 140 generally comprises a communication interface 130, a processor 132, a user interface 133 and a memory device 134. The processor 132 is operatively coupled to the communication device 130 and the memory device 134. In some embodiments, the processing device 132 may send or receive data from the mobile computing device, to the electronic wallet management system 102 via the communication device 130 over a network 101. As such, the communication device 130 generally comprises a modem, server, or other device for communicating with other devices on the network 101.

As further illustrated in FIG. 3, the mobile computing device comprises a mobile wallet application 136 which is executable by the processor 132. In the embodiment illustrated in FIG. 1, mobile wallet application 136 allows the mobile computing device 140 to be linked to the electronic wallet management system 102 to communicate, via a network 101. The mobile wallet application 136 may also allow the mobile computing device 140 to connect directly (i.e. locally or device to device) with the financial account system 180 for creating a creating a financial account. The mobile wallet application 136 may perform one or more of the steps and/or sub-steps discussed herein and/or one or more steps not discussed herein. For example, in some embodiments, the mobile wallet application 136 may enable a user to interact with a graphical representation to communicate a request to the electronic wallet management system 102 for transferring funds available to an electronic wallet to a financial account.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

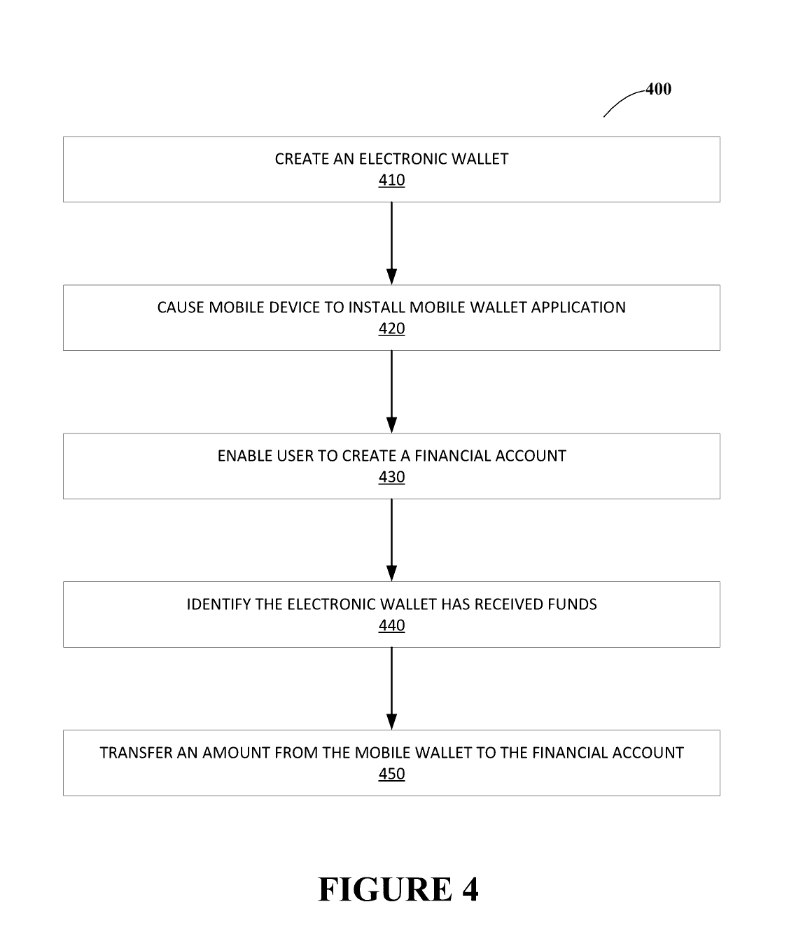

Referring now to FIG. 4, a method 400 for facilitating digital wallet transfers is described. The method 400 comprises a step 410 for creating an electronic wallet, a step 420 for causing a mobile device to install a mobile wallet application 136, a step 430 for enabling a user to create a financial account, step 440 for identifying the electronic wallet has received funds, and a step 40 for transferring an amount from the mobile wallet to the financial account.

Step 410 demonstrates creating an electronic wallet. The electronic wallet management system 102 creates the electronic wallet by associating a user with an electronically stored account balance. Initially, the account balance available is zero. In some embodiments, the electronic wallet management system 102 may receive an identifier (e.g. email, phone number) for identifying the electronic wallet. This identifier may be used to receive funds into the electronic wallet. For example, the user may give a payor the identifier. Using the identifier, the payor may request an amount of funds be transferred to the electronic wallet of the user. The electronic wallet management system 102 may receive the request with the identifier and complete the transfer by making funds available to the electronic wallet.

Step 420 demonstrates causing a mobile device to install a mobile wallet application 136 for enabling a user to manage the electronic wallet. In some embodiments, the mobile wallet application 136 causes the mobile device 140 to communicate with the electronic wallet management system 102 to receive electronic wallet information and communicate requests for managing the electronic wallet. With respect to the mobile wallet information, such information may include an amount of funds available to the mobile wallet, past purchases made using the electronic wallet, financial accounts that are connected to the electronic wallet, and the like. With respect to requests the mobile wallet application 136 may communicate to the electronic wallet management system 102, such requests may include connecting a financial account to the electronic wallet, transferring funds from a connected financial account to the electronic wallet, transferring funds available to the electronic wallet to a financial account connected to the electronic wallet, completing a purchase using funds available to the electronic wallet, and receiving a payment from a payor.

After installing the mobile wallet application 136 on the mobile device, the electronic wallet may enable the user to create a financial account for receiving funds from the electronic wallet, as demonstrated in step 330. In some embodiments, the electronic wallet management system 102 may enable to user through the mobile wallet application 136 to enter in user information for creating the financial account. In some embodiments, the electronic wallet management system 102 may create an incentive for the user to create the account. For example, the electronic wallet management system 102 may provide fee free transfers from the financial account to the electronic wallet. In other embodiments, enabling the user to create a financial account may include presenting the user with information related to third-party financial institutions for creating the account. After the user has created the account, the electronic wallet management system 102 may connect the electronic wallet with the newly created financial account.

With the electronic wallet created and linked to a financial account, the electronic wallet management system 102 may identify that the electronic wallet has received funds, as demonstrated in step 340. As explained elsewhere, the electronic wallet management system 102 may receive a request to receive funds for the electronic wallet. Such request may be based on a user being a merchant and the user finalizing a transaction for a sale of a product or service. In other embodiments, the electronic wallet management system 120 may review the amount of funds available to the electronic wallet to determine whether the amount has increased, thus indicating the electronic wallet has received funds.

Based on the user receiving funds, the electronic wallet management system 102 may transfer funds available to the electronic wallet to a financial account. In some embodiments, the electronic wallet management system 102 enables the user to request the transfer. In other embodiments, the transfer is automatic based on identifying the electronic wallet has received funds. In yet other embodiments, the electronic wallet management system 102 determines an amount of funds available to the electronic wallet to the financial account. In some embodiments, the transfer may be for all the funds available to the electronic wallet. While in other embodiments, the funds may be less than the full amount available to the electronic wallet. Additionally, the electronic wall management system 102 may enable the user to set a maximum amount to make available to the electronic wallet. Using the maximum amount, the electronic wallet management system 102, upon identifying the electronic wallet has received funds, may determine whether the funds available to the electronic wallet based on receiving the funds exceeds the maximum amount. If the maximum amount has been exceeded, the electronic wallet management system 102 may transfer any amount available to the electronic wallet that exceeds the maximum amount to the financial account. For example, User A establishes an electronic wallet and sets a maximum amount value of $100 to be made available to the electronic wallet. The user receives a first amount of funds of $50 and transfers in a second amount from a financial account of $25. Thus, the amount of funds available to the remote wallet is $75. After this, the electronic wallet receives a third amount of $50, thus increasing the amount available to the electronic wallet to $125. The electronic wallet management system 102 determines that the amount available of $125 exceeds the maximum amount value of $100. The electronic wallet management system 102 further determines the amount available to the electronic wallet exceeds the maximum amount value by $25 and transfers an amount equal to $25 from the electronic wallet to a financial account.

In some embodiments, the financial account is an interest bearing account, such as a savings account. In other embodiments, the financial account may be represent multiple accounts. Each of the multiple accounts may be a different type of an account or be used for a particular purpose. For example, a seller may establish an account for paying vendors. Funds may be transferred from the mobile wallet into the multiple accounts using a user-specified formula. In some embodiments, the system, via the application, may enable the user to specify how funds are transferred from the mobile wallet to the multiple accounts.

In other embodiments, the system may monitor multiple wallets to determine whether funds are available or have been received. In such embodiments, each of the mobile wallets may associated with a particular online merchant. The seller may be enabled to transfer the funds from each of the mobile wallets to a specified financial account. In other embodiments, each of the mobile wallets may be associated with a particular financial account.

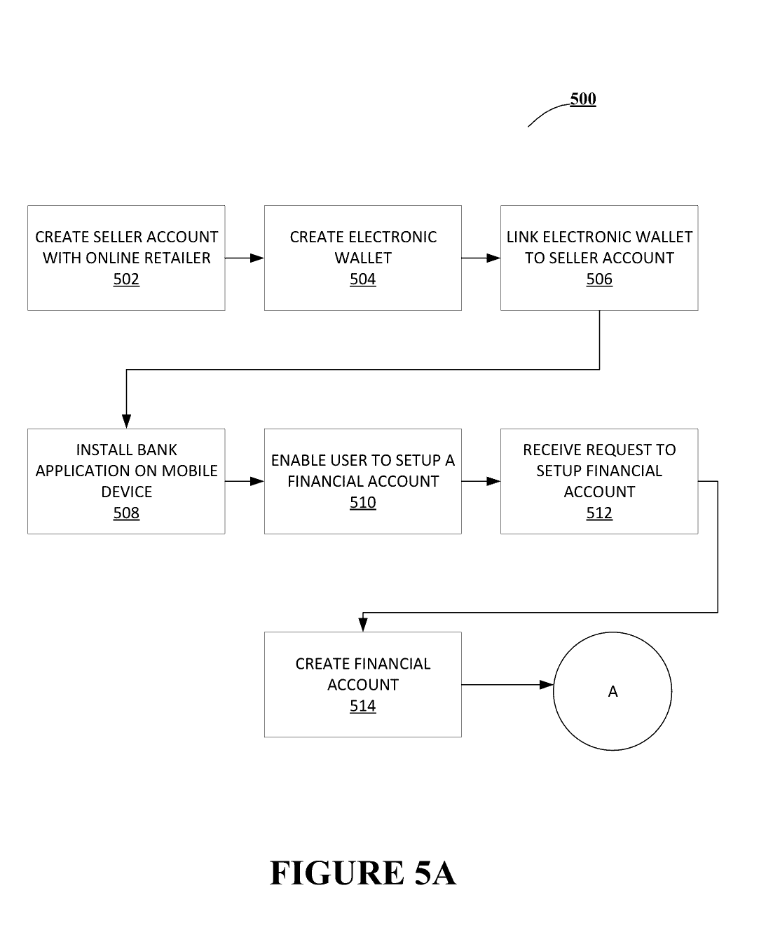

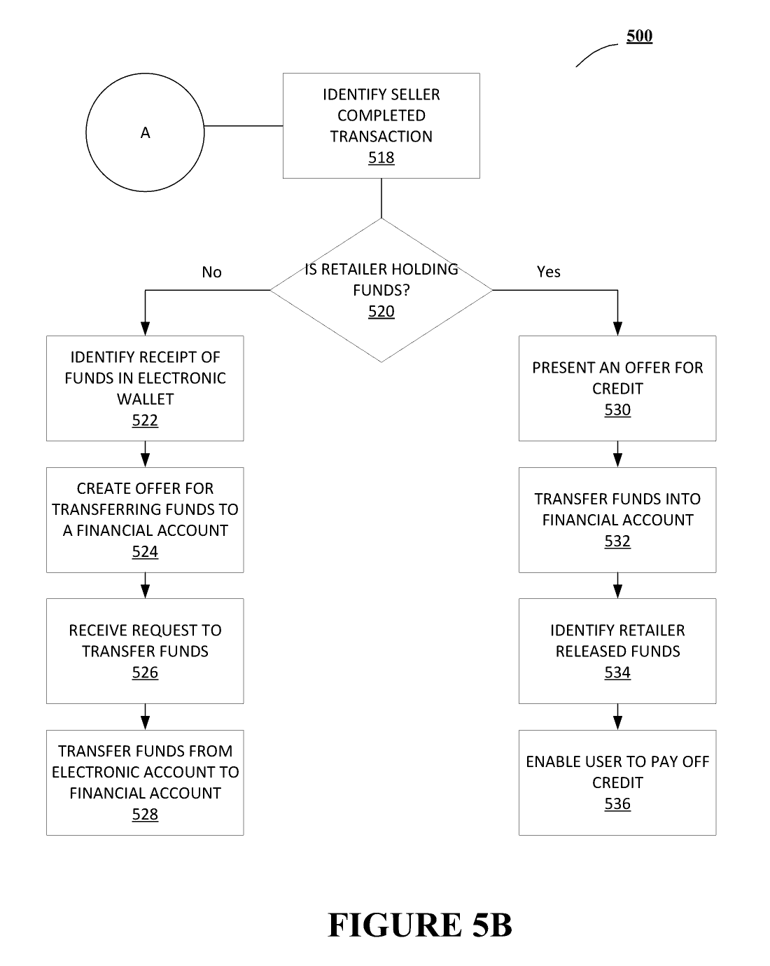

Referring now to FIG. 5A and FIG. 5B, a method 500 for facilitating digital wallet transfers in an electronic commerce setting is described in detail. Step 502 demonstrates creating a seller account with an online retailer. A seller may setup an online sales account with a retailer. In some embodiments, the seller advertises products for sale on a site of the retailer. Using the retailer's site, a customer may select the products for purchase and complete the transaction with the retailer. The seller account is established to direct funds as a result of the transaction between the retailer and the customer. After a transaction is complete, the retailer will communicate a message to the seller detailing the transaction. Typically, the seller is responsible for fulfilling the transaction, which may include shipping the product to the customer. Therefore, the retailer sells the product on behalf of the seller. In some instances, the retailer may hold funds from a sale to ensure that the customer is not going to request a refund. The hold period of the funds may be based on the seller delivering shipping confirmation of the product to the retailer, or a predetermined waiting period (e.g. 30 days).

The electronic wallet may be created as demonstrated in step 410 of FIG. 400. Additionally, the electronic wallet may be designated to receive funds for online transactions.

This may require additional disclosure by the seller depending on governmental regulations. After creating the electronic wallet and setting up a seller account, the electronic wallet may be linked to the seller account as demonstrated in step 506. By linking the electronic wallet to the seller account, when the seller completes a transaction, funds may be transferred to the electronic wallet based on the completion of the transaction.

Referring now to step 508, step 508 demonstrates installing a bank application on a mobile device. The banking application is similar to that described in step 420 of method 400. In addition the banking application may be configured to setup establish a link between the seller account and the electronic wallet as described in step 506. Further, the banking application enables a user to setup a financial account, as described in step 510. In some embodiments, the financial account is setup on behalf of the seller to transfer money from the electronic wallet to the financial account as a result of the user completing a transaction. In other embodiments, the user may transfer funds from the financial account to the electronic wallet. The financial account may be typical to that offered by a financial institution (e.g. checking, savings, investment). In other embodiments, the financial account must meet the same regulatory requirements as the electronic account.

Based on the user interacting with the banking application, the banking application may submit a request to setup a financial account, as defined in step 512. The banking application may submit details about the type of bank account (e.g. checking, savings), holders of the account, withdrawal rules, and the like. Creating the financial account is defined by step 514 and may be accomplished in any typical method for setting up an account.

Now referring to step 518, step 518 demonstrates monitoring the seller account to determine that the seller has completed a transaction. As defined earlier, the transaction may have been completed through the online retailer site. In other embodiments, the sale may be completed through a site managed and operated by the seller. However, in such instances, the handling of funds may be completed through a third-party payment gateway. In some embodiments, the seller's site receives payment information of a customer and transmits such information to the third-party payment gateway. The third-party payment gateway processes the payment and returns a response whether processing the payment was successful. In other embodiments, the seller's site redirects the customer to a site operated by the third-party gateway and submits details related to the transaction (e.g. amount of the transaction). The customer may enter in payment details into the third-party gateway site and submit the payment details for processing the payment. The third-party payment gateway may then process the payment and submit a response back to the seller's site demonstrating whether the payment was processed successfully.

Where a third-party gateway is used, the gateway may perform the same functions as a retailed with respect to holding funds, as demonstrated in step 520. As demonstrated in step 520, a determination is made as to whether the retailer or third-party payment gateway is withholding funds as explained herein. In the event that funds are not withheld, the method 500 may advance to step 522. Alternatively, if the funds are withheld, the system may advance to 530. In other embodiments, even if the funds are withheld, the system may wait until funds are released and then advance to step 522. As demonstrated in step 522, the system identifies that the electronic funds have received the funds from the transaction. Such determination may be made based on monitoring the balance of the electronic wallet.

After determining the electronic wallet has received funds, an offer may be created to incentivize the seller to transfer funds from the electronic wallet to the financial account. In some embodiments, the offer may be a percentage increase of the funds. In other embodiments, the offer may be for a product or service, or a discount towards a product or service. While in other embodiments, the offer may be for an alternative monetary reward such as reward points. In other embodiments, the offer may be created based on the amount of funds available to the electronic wallet. For example, the seller may complete a first transaction for $20 which is transferred to the electronic wallet for use by the electronic wallet. An offer may be generated for 50 reward points if the seller transfers the funds available to the electronic wallet to the financial account. The seller may then complete a second transaction for $50 which is made available to the electronic wallet prior to the seller transferring the $20. The electronic wallet now has an available balance of $70. A second offer may be generated for 100 reward points based on the user transferring over the amount available to the electronic wallet. In other embodiments, the offer may be based on a unit transfer. For example, the offer may be for 1 reward point for every dollar transferred. In other embodiments, the offer may be tiered. Following the earlier example of one point for every dollar, the offer may include 2 points for every dollar transferred over $50. Therefore, if the seller transferred $75, the seller would receive 50 points for the first $50, and 50 points for the additional $25 dollars passed the $50 mark. In any case, the offer may be communicated to the seller. In some specific embodiments, the banking application may be further configured to receive and display offers to the seller. In such embodiments, the offer may be communicated to the banking application for display to the seller.

Referring now to step 526, based on communicating the offer, the seller may elect to transfer at least a portion of funds from the electronic wallet to the financial account. The banking application may provide functionality to the user to request such a transfer. In some embodiments, the banking application may enable the user to transfer all the funds from the electronic wallet to the financial account. In other embodiments, the banking application may enable the user to transfer a portion of funds from the electronic wallet to the banking account. While in other embodiments, the banking application may enable the user to automatically transfer funds from the electronic wallet to the banking account. With respect to automatic transfer of funds, any amount of funds that are made available to the electronic wallet may be transferred to the financial account. While in other embodiments, the seller may elect to establish a maximum amount of funds available. Where such is the case, any amount of funds that is made available to the electronic wallet that exceeds the maximum amount of funds available is automatically transferred to the financial account. For example, the seller may establish a maximum amount of funds available at $100 and an electronic wallet may have an available balance of $75. If the seller completes a transaction for $50, the new available balance would increase to $125 or $25 above the maximum amount of funds available. The $25 would be automatically transferred from the electronic wallet to the financial account. The actual transfer of funds is described in step 528. The transfer may occur using any method typical for transferring funds (e.g. ACH transfer). In addition, where the electronic account and the financial account are managed by a similar institution, the transfer may be done internal to the institution.

Referring back to step 520, if the retailer does hold funds, the method 500 may advance to step 530. Step 530 demonstrates offering credit to the seller. As defined earlier, the retailer may hold funds for a variety of reasons which may place a financial burden on the seller. For example, the retailer may place a 30 day hold on all funds that result from seller transactions. The seller may have to replace inventory but would not necessarily be able to until after the receiving the funds after the 30 day hold. As a result, an offer of credit may be made to the seller. Such offer for credit may be based on the amount of transaction. In one embodiment, the credit may equal the amount of the transaction. In another embodiment, the credit may be less than the amount of the transaction. For example, the credit may be 80% of the transaction amount. In this manner, the seller would receive instant funds for purchasing new products with the proceeds of the transaction as collateral.

Based on the user accepting the offer of credit, funds are transferred into the financial account, as described in step 532. The funds are available to the seller as the seller wishes. However, the offer may state that the seller is liable for any paying back the credit. Typically, the seller would pay the credit back with the proceeds of the transaction, and in some embodiments, the seller may elect to automatically pay off the credit with proceeds of the transaction.

As described in step 534, the electronic wallet is analyzed to identify when the retailer releases the funds associated with the proceeds. When the system determines the proceeds have been released, the banking application may be used to enable the user to transfer the funds available to the electronic wallet to pay off the credit, as described in 536. Additionally, as described in step 524, an offer may be generated to incentivize the user to pay off the credit.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for enabling a user to transfer funds from a mobile wallet to a financial account, the system comprising:
a memory;
one or more processors;
executable code stored in memory that when executed by the one or more processors, causes the one or more processors to:
create an electronic wallet capable of receiving funds from an online transaction;
cause a mobile device to install a banking application for managing the electronic wallet, wherein the banking application enables a user to create a financial account and transfer funds available to the electronic wallet to the financial account;
create a financial account capable of receiving funds from the electronic wallet based on the user interacting with the banking application;
identify that the electronic wallet has received funds; and
transfer an amount of funds available to the electronic wallet to the financial account based on identifying the electronic wallet has received funds.

2. The system of claim 1, wherein the executable code further causes the one or more processors to identify an online merchant account used by the user to perform a transaction, wherein the user is a merchant of the transaction, wherein the electronic wallet receives funds as a result of the user completing a transaction, and wherein identifying that the electronic wallet has received funds is based on determining the user completed the transaction.

3. The system of claim 2, wherein the transaction is held for a waiting period; wherein the executable code further causes the one or more processor to:
extend credit to the electronic wallet during the waiting period; and
receive proceeds of the transaction.

4. The system of claim 1, wherein the executable code further causes the one or more processors to receive a maximum balance for the electronic wallet; determine that the amount of funds available to the electronic wallet exceeds the maximum balance of the electronic wallet; wherein transferring an amount of funds available to the electronic wallet to the financial account is based on ensuring the funds available to the electronic wallet are not less than the maximum balance.

5. The system of claim 1, wherein the banking application enables the user to make a request that at least a portion of the funds available to the electronic wallet are transferred to the financial account; wherein the executable code further causes the one or more processors to receive the request; and wherein transferring the amount of funds available to the electronic wallet to the financial account is further based upon receiving the request.

6. The system of claim 1, wherein the financial account is an interest bearing account.

7. The system of claim 1, wherein the executable code further causes the one or more processors to determine an incentive for causing the user to transfer a portion of the funds available to the electronic wallet from the electronic wallet to the financial account; cause the banking application to present the incentive to the user; receive a request to transfer the portion of the funds available to the electronic wallet; and wherein complete the incentive based on receiving the request to transfer the portion of the funds available to the electronic.

8. A computer program product comprising a non-transient computer readable memory configured to store computer-executable instructions executed by one or more processors, the computer-executable instructions comprising instructions to:
create an electronic wallet capable of receiving funds from an online transaction;
cause a mobile device to install a banking application for managing the electronic wallet, wherein the banking application enables a user to create a financial account and transfer funds available to the electronic wallet to the financial account;
create a financial account capable of receiving funds from the electronic wallet based on the user interacting with the banking application;
identify that the electronic wallet has received funds; and
transfer an amount of funds available to the electronic wallet to the financial account based on identifying the electronic wallet has received funds.

9. The computer program product of claim 8, wherein the computer executable instructions further comprise instructions to identify an online merchant account used by the user to perform a transaction, wherein the user is a merchant of the transaction, wherein the electronic wallet receives funds as a result of the user completing a transaction, and wherein identifying that the electronic wallet has received funds is based on determining the user completed the transaction.

10. The computer program product of claim 9, wherein the computer executable instructions further comprise instructions to:
extend credit to the electronic wallet during the waiting period; and
receive proceeds of the transaction.

11. The computer program product of claim 8, wherein the computer executable instructions further comprise instructions to receive a maximum balance for the electronic wallet; determine that the amount of funds available to the electronic wallet exceeds the maximum balance of the electronic wallet; wherein transferring an amount of funds available to the electronic wallet to the financial account is based on ensuring the funds available to the electronic wallet are not less than the maximum balance.

12. The computer program product of claim 8, wherein the banking application enables the user to make a request that at least a portion of the funds available to the electronic wallet are transferred to the financial account; wherein the executable code further causes the one or more processors to receive the request; and wherein transferring the amount of funds available to the electronic wallet to the financial account is further based upon receiving the request.

13. The computer program product of claim 8, wherein the financial account is an interest bearing account.

14. The computer program product of claim 8, wherein the computer executable instructions further comprise instructions to determine an incentive for causing the user to transfer a portion of the funds available to the electronic wallet from the electronic wallet to the financial account; cause the banking application to present the incentive to the user; receive a request to transfer the portion of the funds available to the electronic wallet; and wherein complete the incentive based on receiving the request to transfer the portion of the funds available to the electronic.

15. A method for enabling a user to transfer funds from a mobile wallet to a financial account, the method comprising:
creating an electronic wallet capable of receiving funds from an online transaction;
causing a mobile device to install a banking application for managing the electronic wallet, wherein the banking application enables a user to create a financial account and transfer funds available to the electronic wallet to the financial account;
creating a financial account capable of receiving funds from the electronic wallet based on the user interacting with the banking application;
identifying that the electronic wallet has received funds; and
transferring an amount of funds available to the electronic wallet to the financial account based on identifying the electronic wallet has received funds.

16. The method of claim 15, wherein the method further comprises identifying an online merchant account used by the user to perform a transaction, wherein the user is a merchant of the transaction, wherein the electronic wallet receives funds as a result of the user completing a transaction, and wherein identifying that the electronic wallet has received funds is based on determining the user completed the transaction.

17. The method of claim 16, wherein the method further comprises:
extending credit to the electronic wallet during the waiting period; and
receiving proceeds of the transaction.

18. The method of claim 15, wherein the method further comprises receiving a maximum balance for the electronic wallet; determine that the amount of funds available to the electronic wallet exceeds the maximum balance of the electronic wallet; wherein transferring an amount of funds available to the electronic wallet to the financial account is based on ensuring the funds available to the electronic wallet are not less than the maximum balance.

19. The method of claim 15, wherein the banking application enables the user to make a request that at least a portion of the funds available to the electronic wallet are transferred to the financial account; wherein the executable code further causes the one or more processors to receive the request; and wherein transferring the amount of funds available to the electronic wallet to the financial account is further based upon receiving the request.

20. The method of claim 15, wherein the method further comprises determining an incentive for causing the user to transfer a portion of the funds available to the electronic wallet from the electronic wallet to the financial account; cause the banking application to present the incentive to the user; receive a request to transfer the portion of the funds available to the electronic wallet; and wherein complete the incentive based on receiving the request to transfer the portion of the funds available to the electronic.
